(19) United States
(12) Patent Application Publication
(10) Pub. No.: US 2006/0110071 A1
(43) Pub. Date: May 25, 2006

(54) Method and system of entropy-based image registration

(76) Inventors: Sim Heng Ong, Singapore (SG); Ek Tsoon Tan, Rochester, MN (US); Chye Hwang Yan, Singapore (SG); Shih Chang Wang, Singapore (SG)

Correspondence Address: CHRISTIE, PARKER & HALE, LLP, PO BOX 7068, PASADENA, CA, 91109-7068, US

(21) Appl. No.: 11/251,613

(22) Filed: Oct. 13, 2005

Related U.S. Application Data
(60) Provisional application No. 60/618,361, filed on Oct. 13, 2004.

(51) Int. Cl. G06K 9/32

(52) U.S. Cl. 382/294

(57) ABSTRACT

A method of entropy-based image registration comprising estimating conditional probability distribution functions (PDFs) between two images as multivariate Gaussian distributions; mathematically relating an entropy of the multivariate Gaussian distributions to a sum of square differences (SSD) between the images; and optimising the registration between the images utilising a cost function based on the SSD.

### FIELD OF INVENTION

The present invention relates broadly to a method of entropy-based image registration, to a system for entropy-based image registration and to a computer readable data storage medium having stored thereon computer code means for instructing a computer to execute a method of entropy-based image registration.

### BACKGROUND

Image registration comprises establishing spatial correspondences between two or more images that share the same subject and aligning images that are taken at different times, or from different positions, or using different modalities.

Image registration is used for example in a mammography technique known as Contrast-enhanced magnetic resonance mammography (CEMRM) typically uses magnetic resonance imaging (MRI) to obtain a 3-D tomography of a human breast. An intravenously-injected paramagnetic contrast agent (e.g. Gd-DTPA) is typically used on patients to enhance vascular structures including hypervascular lesions such as breast cancers. When several images of the same subject are obtained in a time sequence, malignancy may be distinguished by the enhancement over time curve of each image voxel. However, such an analysis cannot typically be directly applied since patient motion due to breathing and discomfiture may affect the imaging. Similarly, a breast is soft and deformable, and thus will not move in a uniform fashion during imaging. As standard methods of image subtraction used in clinical MRI workstations currently do not use formal image registration schemes and also assume negligible patient motion between acquisitions, clinically unacceptable image mis-registration may occur, such that enhancing lesions may be artifactually suppressed or even “created” as a result. Due to CEMRM benefits such as being radiation-free and offering relatively better tissue sensitivity and 3-D tomography than x-ray mammography, if image registration can be made more accurate and reliable, CEMRM can be more widely adopted for breast cancer detection.

CEMRM image registration typically uses one 3-D image as the positional frame of reference. A pre-contrast image is usually taken to be the reference, and subsequent post-contrast images are registered to it. Previous attempts of registering CEMRM differed mainly in the use of transformation models and optimization methods. Existing transformation models comprise rigid only, slice-wise rigid, and non-rigid models while existing optimization methods comprise the minimization of the ratio of variance (or Woods algorithm), optical flow, and maximization of mutual-information. However, problems exist such as rigid transformation being insufficient for capturing the free-form deformation of a breast, a slice-wise rigid model being unable to capture non-rigid deformation and may also introduce artificial deformation between slices, while the Woods algorithm typically does not work as well as the other models with a contrast-enhancement subject, and optical-flow optimization alone typically does not take into account non-uniform change in intensity due to the contrast agent.

In relation to the above, a method, combining global and local motion modeling (i.e. using both rigid and non-rigid registration) and optimizing normalized mutual information, was proposed by Rueckert et ai. [IEEE Trans. Med. Imag., vol. 18, no. 8, August 1999] to reduce registration artifacts. Normalised mutual information is a typically better registration cost function than both optical flow and mutual information because normalised mutual information is independent of image overlap. However, two problems with Rueckert's method were that a relatively higher degree of registration error was present in regions with tumors (or lesions) and that tumor volume was not preserved during imaging. It was found that although registration significantly reduced registration artifacts, the non-rigid registration component of the method may erroneously reduce lesion volume. An incompressibility constraint was subsequently added to the method to prevent lesion volume reduction and the constraint successfully kept lesion volume reduction to less than about 2%. However, one problem arose as lesion volume expansion of up to about 6% was then found. There was also evidence that a tradeoff between artifact reduction and lesion suppression existed when applying the constraint.

In Rueckert's method, the entropy calculations used to obtain normalised mutual information are typically computationally expensive. In addition, optimizing normalised mutual information is currently a nonlinear-time process. Finding mutual information or normalised mutual information is computationally expensive because histograms of both images to be processed have to be obtained. Typically, image intensities are not integer values and nearest neighbor interpolation is insufficient. Further, linear interpolation typically does not allow analytic computation of the derivative of the histogram because sample contributions are not stored while the histogram is computed. Gradient estimation solutions are used instead but higher-order interpolation is typically needed to reduce interpolation artifact patterns in these solutions, thus significantly increasing computational complexity. The Parzen density estimation for higher-order estimation is currently adopted as an alternative to existing methods for finding mutual information or normalised mutual information. Parzen density estimation uses Gaussian density functions centered on non-discrete image samples to find the density contributions at discrete intensity levels. However, finding the mutual information or normalised mutual information is still relatively complex and expensive when using Parzen density estimation.

Hence, there exists a need for a method and system of entropy-based non-rigid image registration to address at least one of the above problems.

### SUMMARY

In accordance with a first aspect of the present invention, there is provided a method of entropy-based image registration comprising, estimating conditional probability distribution functions (PDFs) between two images as multivariate Gaussian distributions; mathematically relating an entropy of the multivariate Gaussian distributions to a sum of square differences (SSD) between the images; and optimising the registration between the images utilising a cost function based on the SSD.

The cost function may comprise a linear combination of terms of derivatives of the SSD.

The images may comprise 3 dimensional images.

The 3 dimensional images may comprise contrast enhancement magnetic resonance mammography (CEMRM) images.

The registration results may be analysed by utilising a scoring technique based on maximum and minimum intensity criteria.

The scoring technique may be further based on an initial enhancement parameter and a post-initial enhancement parameter.

The parameters may be varied to reduce blurring effects.

The method may further comprise lesion segmentation processing.

The registration may comprise rigid and non-rigid registration.

The mathematically relating the entropy of the multivariate Gaussian distributions to the SSD between the images may comprise separating motion variables from a non-uniform change in intensity.

In accordance with a second aspect of the present invention, there is provided a system for entropy-based image registration comprising, means for estimating conditional probability distribution functions (PDFs) between two images as multivariate Gaussian distributions; means for mathematically relating an entropy of the multivariate Gaussian distributions to a sum of square differences (SSD) between the images; and means for optimising the registration between the images utilising a cost function based on the SSD.

In accordance with a third aspect of the present invention, there is provided a system for entropy-based image registration comprising, an estimator for estimating conditional probability distribution functions (PDFs) between two images as multivariate Gaussian distributions; a correlator for mathematically relating an entropy of the multivariate Gaussian distributions to a sum of square differences (SSD) between the images; and a processor for optimising the registration between the images utilising a cost function based on the SSD.

In accordance with a fourth aspect of the present invention, there is provided a computer readable data storage medium having stored thereon computer code means for instructing a computer to execute a method of entropy-based image registration comprising estimating conditional probability distribution functions (PDFs) between two images as multivariate Gaussian distributions; mathematically relating an entropy of the multivariate Gaussian distributions to a sum of square differences (SSD) between the images; and optimising the registration between the images utilising a cost function based on the SSD.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 is a schematic illustration showing the process of a Multivariate Gaussian Estimation (MGE) method in an example embodiment.

FIG. 2 is a probability-intensity graph showing post-contrast plots of images in an example embodiment.

FIG. 3(a) is a picture showing scoring using enhancement constant κ₁=50% in an example embodiment.

FIG. 3(b) is a picture showing scoring using enhancement constant κ₁=100% in an example embodiment.

FIG. 4 is a series of subtracted images and transformation mesh illustrating the images as obtained by the MGE and the Parzen methods.

FIG. 5 is a series of schematic charts showing the indicators of registration quality in the example embodiment.

FIG. 6 is a series of images showing inverted difference maximum-intensity projections (MIPs) of a left breast with a benign hemangioma lesion of about 15 mm diameter in an example embodiment.

FIG. 7 is time-voxel size graph illustrating the times taken for both rigid and non-rigid registration in relation to dataset size in an example embodiment.

FIG. 8 is a schematic drawing illustrating a computer system for implementing an image registration method according to an example embodiment.

FIG. 9 shows a flow chart illustrating an image registration method according to an example embodiment.

### DETAILED DESCRIPTION

An example embodiment described herein relates to an image registration scheme in which can enable artifact removal without artificial lesion suppression.

In the example embodiment, the choice of which geometric transformation model to use when registering images is determined by the type of body registered. The parameters that characterize the transformations in the model determine the number of degrees of freedom. The example embodiment will be described in the context of CEMRM images, more particularly CEMRM images of breast. Registering CEMRM images typically involves modeling of motion. A suitable motion model can utilize fewer transformation parameters while providing an accurate registration. Motion models can be typically classified as global or local.

Geometric Transformations

Rigid transformation is used in the example embodiment to model the global motion of the breast. In R³, the transformation has 6 degrees of freedom relating to translations along and rotations about three cardinal axes (x,y,z), preserving all lengths and angles between lines. Rigid transformation typically belongs to a class of affine transformations that comprise scaling (or dilation) and shearing. Denoting R as the rotation matrix and [tₓ t_{y} t_{z}]^{T} as the translation vector, the general form of an affine transformation is
T_{R}(x,y,z)=R[x y z]^{T}+[tₓ t_{y} t_{z}]^{T}. (1)

On the other hand, local or adaptive motion models typically employ transformations with a much higher degree of freedom. In the example embodiment, a non-rigid transformation for modelling local motion is a 3^{rd} order B-spline model, which can be both sufficiently powerful and efficient. In a multi-resolution non-rigid registration in the example embodiment, a prescribed minimum number of control points are initiated, and the control points are increased in each dimension when optimum registration is obtained at each resolution. Defining Γ as the resolution of non-rigid transformation, the net transformation T can be expressed as a summation of the rigid transformation, T_{R} and non-rigid transformation, T_{NR,Γ} as

$$T = {T}_{R} + {\sum }_{Γ} {T}_{NR , Γ} . \qquad ( 2 )$$

Volume Registration

In the example embodiment, volume registration is applied. In contrast to surface registration techniques that are based on point correspondences, typically no landmarks are used in volume registration. Optical flow (relating to the relationship between brightness variation in an image and the motion field) is used, instead of landmarks, to establish correspondence between images. Assuming that image brightness E is a function of both spatial and temporal coordinates, and is continuous and differentiable in both the spatial and temporal domains, and further, is constant for a moving object, the image brightness constancy equation states that the sum of partial derivatives of E with respect to spatial and temporal variables should be zero, ie.

$${( ( \frac{\partial }{\partial x} , \frac{\partial }{\partial y} , \frac{\partial }{\partial z} ) E )}^{T} ( \frac{ⅆ x}{ⅆ t} , \frac{ⅆ y}{ⅆ t} , \frac{ⅆ z}{ⅆ t} ) + \frac{\partial E}{\partial t} = 0 \qquad ( 3 )$$

During implementation in the example embodiment, the discrete spatial derivative of an image is obtained. As the so-called aperture problem typically confines the reach of the spatial derivative, multi-resolution strategies can be used to reduce the effect of the aperture problem by providing more accurate coarse alignments at lower resolutions, prior to more precise alignments at higher resolutions.

During volume registration, optical flow is used in combination with the optimization of a cost function that determines how well the images are aligned. When the intensity is unchanged, the sum-of-squares difference (SSD) between the reference image (E) and the registered image (E′) can be used as a measure of registration. The SSD is defined as

$$\begin{matrix}SSD = \sqrt{{\sum }_{i}^{n} {( {E}_{i} - {E}_{i}^{′} )}^{2} / n} & ∀ {E}_{i} ∈ E ⋂ {E}^{′} .\end{matrix} \qquad ( 4 )$$

In the example embodiment, a variation of SSD called NSSD (or negative SSD) can also be used as a measure of registration. NSSD can be relatively more useful in estimating the relative amount of motion artifacts in CEMRM because intensities are expected to increase rather than decrease after injecting the contrast agent. NSSD differs from SSD as NSSD only includes pixels that result in negative changes in intensity and is defined as

$$\begin{matrix}NSSD = \sqrt{{\sum }_{i}^{n} {( {E}_{i} - {E}_{i}^{′} )}^{2} / n} & ∀ {E}_{i} ∈ \{ ( {E}_{i}^{′} - {E}_{i} ) < 0 \} .\end{matrix} \qquad ( 5 )$$

Cost Function

In a conventional normalised mutual information (NMI) based cost function of the Rueckert's method, the entropy calculations used to obtain NMI are typically computationally expensive, as mentioned in the background section. Gradient estimation solutions and the Parzen density estimation for higher-order estimation are currently adopted. Parzen density estimation uses Gaussian density functions centered on non-discrete image samples to find the density contributions at discrete intensity levels. However, finding the mutual information or normalised mutual information is still relatively complex and expensive when using Parzen density estimation. Generally, the NMI in entropy-based registration of images E, E′ is defined as:
Y(E,E′)=(H(E)+H(E′))/H(E,E′). (6)
where H(E), H(E′) are the marginal entropies of E, E′ respectively, and H(E,E′) is the joint entropy.

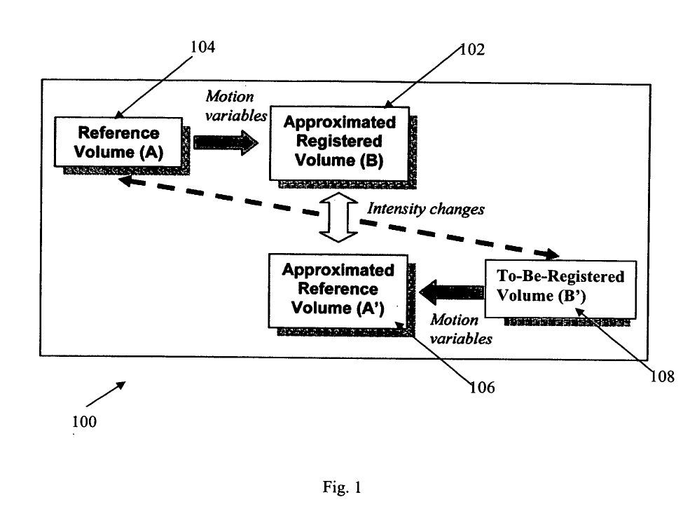

The example embodiment utilises a model that separates motion variables from the non-uniform change in intensity between images by using approximations of the reference volume and the volume to be registered. FIG. 1 shows a schematic flowchart 100 of the example embodiment. A reference volume 104 and a volume to be registered 108 are provided. The motion variables are separated by using an approximated registered volume 102 from the reference volume 104, and using an approximated reference volume 106 from the volume to be registered 108. Registration optimisation proceeds between the approximated registered volume 102 and the approximated reference volume taking into consideration the contrast-enhancement dynamics. In other words, registration is achieved if the intensity changes between the approximated registered volume 102 and the approximated reference volume 106 follow the contrast-enhancement dynamics. The model is referred to hereinafter as Multivariate Gaussian Estimation (MGE).

If the motion variables can be isolated, then the motions can be registered in spite of the presence of the contrast agent. The MGE model assumes that there are two classes of tissues—non-hypervascularized (e.g. non-lesions) and hypervascularized (e.g. lesions and blood vessels). The approximations of the reference registered volumes apply to non-hypervascularized tissues, which typically make up the bulk of the registered volume. Additional assumptions adopted by the MGE model comprise assuming the contrast-enhancement dynamics and motion artifacts belonging to non-hypervascularized tissues may be modeled as Gaussian distributions since CEMRM is a single-modality imaging technique.

By assuming that all conditional probability distribution functions (PDFs) can be modeled as Gaussian distributions, a mathematical relation between the entropy of Gaussian distributions and SSD is employed, demonstrating that the derivative of normalised mutual information with respect to a variable φ is a sum of two linear expressions. The sum of two linear expressions being equated to a gradient expression of the normalised neutral information suggests that optimization can end at a global minima.

Given two images E and E′, where P(X=x, Y=y) is the joint PDF and P(X=x|Y=y) is the conditional PDF, and where X and Y denote values in the histogram of E and E′ respectively, the conditional entropy (i.e. Shannon's definition) with respect to E′, is

$$H ( E \vert {E}^{′} ) = - {\sum }_{Y , X} P ( X = x , Y = y ) log ( P ( X = x \vert Y = y ) ) . \qquad ( 7 )$$

In the case where P(X=x|Y=y)∀Y [symbol] N(m_{y},σ_{y}²), i.e. where each integer value of Y is approximated by a 1-D Gaussian distribution of mean, m_{y} and variance, σ_{y}² . Let ƒₓ₁ and ƒ_{y1} denote the mapping functions that create two new signals, A and B. A and B are defined by A=E(ƒₓ₁(X=x)), and B=E′(ƒ_{y1}(Y=y)), where
ƒₓ₁: x→x/\sqrt{2}σ_{y}, and (8)
ƒ_{y1}: y→m_{y}/\sqrt{2}σ_{y}. (9)

By substituting the derived signals from eq. (8) into eq. (7), the final expression of H(E|E′) is

$$H ( E \vert {E}^{′} ) = \frac{1}{2} log ( 2 π ) + {\sum }_{Y} P ( Y = y ) log ( {σ}_{y} ) + SSD ( A , B ) . \qquad ( 10 )$$

By similar derivation as that reflected in eq. (8), two other new signals A′ and B′ are also derived for the conditional entropy with respect to E. By substituting the derived signals A′ and B′ into eq. (7), H(E′|E) is

$$H ( {E}^{′} \vert E ) = \frac{1}{2} log ( 2 π ) + {\sum }_{X} P ( X = x ) log ( {σ}_{x} ) + SSD ( {A}^{′} , {B}^{′} ) . \qquad ( 11 )$$

An assumption is made in the example embodiment where the 1^{st} derivatives (with respect to a transformation variable) of the means and variances are negligible.

When the conditional PDFs are substituted into the general NMI equation (6), the derivative of the NMI with respect to a control point is a linear combination of two terms of SSD derivatives, or

$$\frac{\partial Y}{\partial ϕ} ≅ ( \frac{\partial SSD ( A , B )}{H ( E , {E}^{′} ) \partial ϕ} ) + ( \frac{1}{Y} - \frac{1}{H ( E , {E}^{′} )} ) \frac{\partial SSD ( {A}^{′} , {B}^{′} )}{\partial ϕ} \qquad ( 12 )$$

The above gradient expression suggests that optimization using a cost function based on the MGE method, being based on a linear combination of terms, should not terminate at a local minima but rather at a global minima. Observations of results for test cases are consistent with the MGE model of the example embodiment.

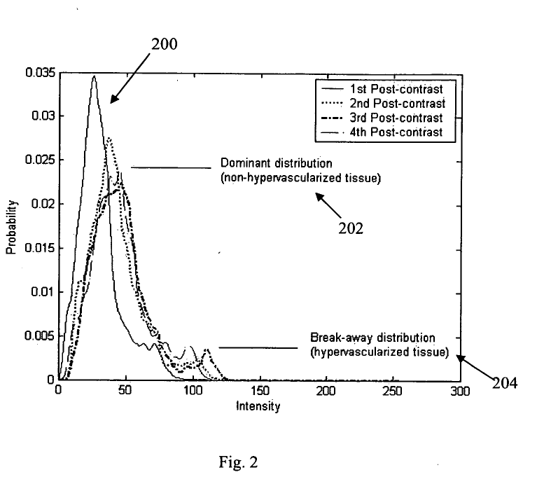

FIG. 2 is a probability-intensity graph showing post-contrast plots of images in the example embodiment. FIG. 2 shows a set of conditional PDFs 200 that clearly reflects a dominant distribution 202 and a break-away distribution 204. The break-away distribution 204 corresponds to lesions and also resembles the typical signal enhancements arising from the contrast agent. When the conditional PDFs 200 are compared against an estimated Gaussian curve (not shown), the Euclidean estimation error is at maximum about 0.0029 (and the mean is about 0.0011), which is relatively much lesser than the near-unity peak densities.

In the example embodiment, in addition to achieving an optimization expression with no local minima, the MGE is also less computationally complex than utilising existing methods in finding normalised mutual information (or mutual information). Gaussian distributions have been used to estimate the joint PDF (JPDF) using expectation maximization to parameterize the JPDF as Gaussian distributions in multi-modality registration. It can be seen that the MGE model is applicable to CEMRM registration because there is a dominant distribution that represents the bulk of each image.

Processing And Results

To verify the registration scheme in the example embodiment, a total of 22 CEMRM patient datasets were obtained, yielding 42 sets of registration of which 22 breasts had benign or malignant lesions. Image acquisition was done using a GE Signa 1.5 Tesla coil MRI scanner with 3-D fast-spoiled gradient echo and no spectral fat suppression (TR=25.6 ms, TE=3 ms, fractional echo, Flip angle=30°, FOV=32 to 40 cm). The contrast agent used was MagneVist Gd-DTPA of concentration 0.2 mmol/kg. A typical dataset has 5 scans (256×256×24 voxels) of non-isotropic resolution (1.05 mm×1.05 mm×5.45 mm). Variations to the protocol of obtaining each dataset are mainly in the number of slices, which can vary from 16 to 56, depending on the volume size to be acquired. The contrast agent is injected after the first scan, and post-contrast scans follow in the next 5 to 20 minutes. Each 3-D scan typically requires about 30-60 seconds of acquisition time, depending on the number of slices.

The CEMRM begins with pre-processing, followed by rigid registration and non-rigid registration. As each breast is registered separately for efficiency, segmentation of the breast contour for each breast is carried out. Manual segmentation was chosen for reasons such as: (i) breast intensities can vary significantly from patient to patient; (ii) wrap-around effect due to sampling aliasing; (iii) “ghosting” effect due to patient movement during acquisition; and (iv) the region-of-interest required may not encompass the entire breast. A maximum intensity projection (MIP) is taken in the axial direction to produce a 2-D image that can be manually segmented relatively easily.

Rigid registration using normalised mutual information is implemented using gradient ascent or descent. Learning rate adaptation (LRA) using the known SuperSAB method with an acceleration (ie. “bold driver”) rate of about 1.2 and a deceleration (ie. “annealing”) rate of about 0.5 is implemented. Benefits of using LRA in the example embodiment include: (i) higher normalised mutual information values (about 2.1% improvement on average), (ii) less oscillatory optimization progess, and (iii) faster convergence. Single-resolution rigid-registration (at the highest resolution) is deemed to be sufficient in the example embodiment because global motion is typically minute (or typically within one pixel range). As for non-rigid registration, gradient ascent is employed in a hierarchical, multi-resolution fashion, without implementing LRA to prevent over-fitting in lower resolutions. In the example embodiment, a regularization term is also added into the cost function to smooth the non-rigid transformation. The MGE method is used in the above registration process for optimization purposes.

Following the registration process, a registration and viewing software for CEMRM is developed to facilitate multi-view comparisons and further analysis of registration results. A tool for lesion analysis was integrated with the software to distinguish malignancy. Clinical studies have consistently shown that an analysis based on image intensity obtained from three time points (also known as the 3 Time-Point or 3TP method) can typically be used to distinguish lesions from normal tissue and also, malignant lesions from benign ones. The overall imaging time of the standard 3TP method, including acquisition times of about 3 to 5 minutes per sequence, is much longer than the imaging time for the dynamic CEMRM acquisition scheme in the example embodiment, where rapid serial scanning is completed within 5 minutes of the contrast agent injection. The acquisition scheme in the example embodiment is therefore more sensitive to rapid changes in wash-in enhancement than the slower delayed wash-out phase. The delayed wash out phase typically occurs from 5 minutes onwards, after injection of the contrast agent. Thus, the 3TP method has been modified with a relatively robust scoring system (shown in Table 1 below) to analyze the obtained registration results.

TABLE 1
Modified scoring system for CEMRM

| | | Benign | |
|---|---|---|---|
| | None (Score = 0) | (Score = 1) | Malignant (Score = 2) |
| Conditions: | (ω₁ ≦ κ₁) | (ω₁ > κ₁) | (ω₁ > κ₁) |
| | | AND | AND |
| | | (ω₂ > κ₂) | (ω₃ > κ₂) |
| Definitions: | ${ω}_{1} = \frac{max ( {I}_{2} , {I}_{1} ) - {I}_{0}}{{I}_{0}} \times 100 \% ,$ | | |
| | ${ω}_{2} = \frac{min ( {I}_{3} , {I}_{4} ) - max ( {I}_{1} , {I}_{2} )}{max ( {I}_{1} , {I}_{2} )} \times 100 \% ,$ | | |
| | ${κ}_{1} ∈ [ 30 \% , 200 \% ] , {κ}_{2} ∈ [ - 20 \% , 50 \% ]$ | | |

By using a maximum and minimum criteria, the scoring system is relatiavely more sensitive to variations in contrast-enhancement dynamics. In addition, the initial enhancement (or wash-in enhancement) and post-initial enhancement (or wash-out phase) constants, κ₁ and κ₂, are changed interactively to make the scoring system more robust to blurring effects on smaller lesions. A wide range of values are allowed for κ₁ and κ₂ to accommodate the significantly higher wash-in characteristic of the imaging protocol used in the example embodiment.

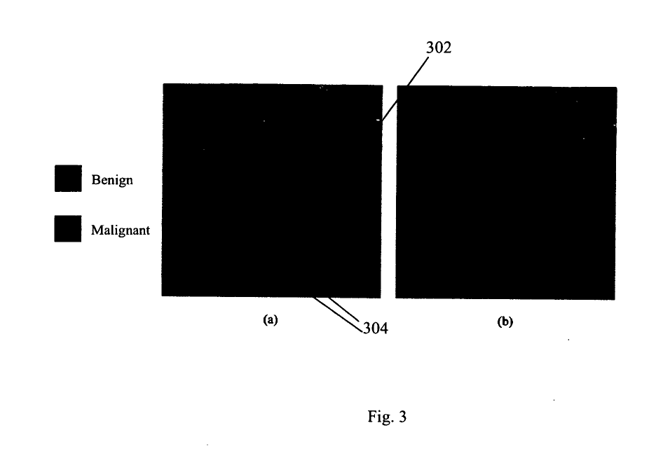

FIG. 3 are two pictures showing scoring using different enhancement constants. FIG. 3(a) is a picture with enhancement constant κ₁=50% while FIG. 3(b) is a picture with enhancement constant κ₁=100%. The dark regions in the pictures indicate lesions found using the modified 3TP method.

The effects of varying κ₁ can be observed, where a benign hemangioma 302 of about 15 mm in diameter is shown.

A characteristic of lesions (both malignant and benign), as well as blood vessels, is a high and rapid initial signal enhancement, after injection of the contrast agent. Thus, to apply lesion segmentation using the modified 3TP scoring method, as illustrated in FIG. 3(b), setting κ₁=100% is optimal in lesion segmentation in the example embodiment. The lesions regions are excluded from the registration algorithm of the example embodiment. The Gaussian estimation error from the MGE model can be approximately halved when lesion segmentation is applied, thus implying that lesion segmentation improves the MGE model. Lesion segmentation enables the MGE model to be more robust as information is taken from all sequences. In addition, the lesion volume does not contribute to registration so that there are no substantial changes in lesion volume (ie. leading to low lesion volume reduction), except for changes caused by genuine correction to motion artifacts outside the lesion.

Referring to FIG. 3(a), the scoring system may pick up a small amount of motion artifacts e.g. 304 on the breast boundary. To overcome this effect, lesion segmentation is applied only in the non-rigid phase of registration and not in the rigid phase. Rigid registration is largely invariant to segmentation of lesions as the optimum transformation is typically guided by the relatively strong image gradient of the breast boundaries. Thus, performing rigid registration without lesion segmentation does not significantly distort lesions and can retain the breast boundaries in the example embodiment.

After obtaining the experimental results, the effectiveness of the MGE model is verified against the existing Rueckert's method and compared with the Parzen density estimation method. First, the differences in the coordinates after transformation are found. Denoting T_{P} as the set of registered coordinates using Rueckert's method, T_{M} as the set of registered coordinates using the MGE method, and/as the set of original coordinates, the deviation for the cardinal directions is determined as

$$Δ T = \frac{\sum {( {T}_{P} - {T}_{M} )}^{T} ( {T}_{P} - {T}_{M} )}{\sum {( {T}_{P} - I )}^{T} ( {T}_{P} - I )} \times 100 \% . \qquad ( 13 )$$

Based on data obtained in the example embodiment, average deviations of 5.7% and 23.9% for the slice plane (x and y) and through-slice directions (z) respectively are obtained. The deviations are considered relatively small because the alignment along the cardinal directions resulting from non-rigid registration is typically within pixel distances, such that minute opposing transformations can create a huge percentage deviation based on the Euclidean definition for ΔT.

It would be appreciated by a person skilled in the art that both the Parzen density estimation and the MGE methods can each be used for two purposes. On the one hand, the Parzen density estimation and the MGE methods can be used to compute values for e.g. normalised mutual information of two given images post-registration, i.e to evaluate registration quality. On the other hand, the Parzen density estimation and the MGE methods can be used in the cost function during optimization as part of the registration processing. Optimization typically ends when the cost function used arrives at a minimum point. Thus, an optimising expression may not be suitable if it terminates at a local minima instead of a global minima.

Conventional NMI, i.e. using the Parzen estimation, as well as NSSD and SSD are identified as indicators of registration quality. To compare the extent of improvement the MGE method has over the existing Parzen density estimation, the measurements of registration quality from the MGE method are normalised against the measurements found using the Parzen density estimation. The normalized measurements for the rigid and non-rigid registrations are denoted by K_{Rigid} in eq. (14) and K_{Non-rigid} in eq. (15) respectively. For comparison purposes, positive K values indicate better performance of the MGE method over the Parzen density estimation while zero indicates equal performance between the two methods. λ_{Rigid} and λ_{Non-rigid} and denote the measurements for the rigid, non-rigid registrations from the MGE method respectively, while ζ_{Rigid} and ζ_{Non-rigid} denote the measurements from the Parzen density estimation method. λ_{Original} and ζ_{Original} refer to cost measurements (NMI, NSSD or SSD) without registration.

$$\begin{matrix}{K}_{Rigid} = \frac{{λ}_{Rigid} - {λ}_{Original}}{{ζ}_{Rigid} - {ζ}_{Original}} \times 100 \% & ( 14 ) \\ {K}_{Non \text{-} rigid} = \frac{{λ}_{Non \text{-} rigid} - {λ}_{Rigid}}{{ζ}_{Non \text{-} rigid} - {ζ}_{Rigid}} \times 100 \% & ( 15 )\end{matrix}$$

TABLE 2
Normalized measurements of improvement
of MGE over Parzen density estimation

| Measurement | Registration | Max (%) | Min (%) | Average (%) |
|---|---|---|---|---|
| Conventional NMI | Rigid | 17.3 | −0.2 | 9.1 |
| | Non-rigid | 0.12 | −8.1 | −2.2 |
| NSSD | Rigid | 6.2 | −1.2 | 2.1 |
| | Non-rigid | 18 | −3.5 | 9.8 |
| SSD | Rigid | 15.2 | 0.6 | 6.9 |
| | Non-rigid | −5.1 | −21 | −11 |

Table 2 summarises the results of the comparison. It is noted that while different measurement types, namely conventional NMI, NSSD, and SSD were used to measure the resultant registration, the cost functions used in the registration optimisations themselves were based on NMI using the MGE method of the example embodiment or conventional MNI. On the average, the results in Table 2 show that the MGE method performs better than Parzen density estimation, for all measurement types in the rigid registration phase. This is despite the fact that the conventional NMI evaluation itself uses the Parzen density estimation. The results suggest that optimization using the conventional NMI based on the Parzen estimation is more prone to early termination of the cost function in a local minima.

For non-rigid registration, however, the MGE method performed better in the NSSD measurements only, in the example embodiment. The NSSD measurements are a more suitable gauge of registration quality in the example embodiment because the NSSD measurements exclude positive intensity increase due to contrast enhancement. However, it is noted here that NSSD is not suitable as an actual cost function during registration optimisation, due to its non-linear nature. The SSD is typically unsuitable for CEMRM because it cannot account for the non-uniform intensity changes due to the contrast enhancement. As for conventional NMI measurements, an optimum or higher NMI value may not be desirable in non-rigid registration, as will be described in the following paragraph. Therefore, the MGE method performs better than the Parzen density estimation not only in the rigid phase but also in the non-rigid phase based on the most suitable measurement criteria used, i.e. the NSSD measurement criteria (compare Table 2).

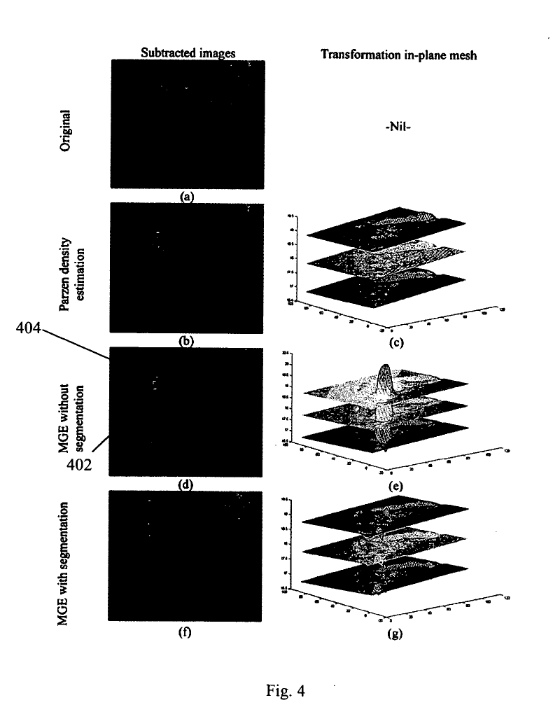

It is noted that when lesion segmentation was not applied during registration, the NMI values obtained were higher (1.9% average improvement) for the MGE method than the Parzen density estimation. This did not, however result in better registration, as artificial deformations in regions near lesions were observed. FIG. 4 is a series of subtracted images and transformation in-plane meshes illustrating the images as obtained by the MGE and the Parzen methods. Referring to FIG. 4(d), the higher NMI value measured for the MGE method registration optimisation did not actually reflect a better registration as artificial deformations e.g. at numeral 402 in regions near lesions e.g. 404 were observed. FIG. 4(e) shows a deformation towards a lesion resulting in an image which is erroneous. From the transformation visualisation illustrated in FIG. 4(e), it can be seen that free-form deformation has warped normal tissue surrounding the lesion towards the lesion, resulting in a loss of lesion volume. A relatively large amount of shearing (shown as 3D transformation) is observed in FIG. 4(e). The deformation in FIG. 4(e) typically happens if the lesion is not segmented from the registration algorithm. The MGE method of the example embodiment segments the lesions or other vascular regions. The existing method (ie. Rueckert et al method) does not do that.

On the other hand, when lesion segmentation was applied during registration using MGE, which yielded a worse conventional NMI registration evaluation than for the Parzen estimation as shown in table 2, the resulting transformation in FIG. 4(f), appeared not only in a form much closer to that of the Parzen density estimation in FIG. 4(b), but the lesion volume also did not appear to be reduced while motion artifacts were corrected for. It is mentioned in the literature [Schnabel et al., “Validation of Non-rigid Registration using Finite Element Methods: Application to Breast MR Images”, IEEE Transactions in Medical Imaging, vol. 22, no. 2, February 2003] that analysis on Rueckert's method potentially results in reduced lesion size. This is not demonstrated in the example embodiment. The MGE method excludes the lesion from the registration process so that there is no artificial deformation.

This illustrates that conventional NMI may not be a suitable measure for CEMRM image registration. The comparison between FIGS. 4(b) and 4(f) shows that registration using the Parzen density estimation can potentially result in artificial deformations and this may explain why lesion volume loss exists when using Rueckert's method for CEMRM.

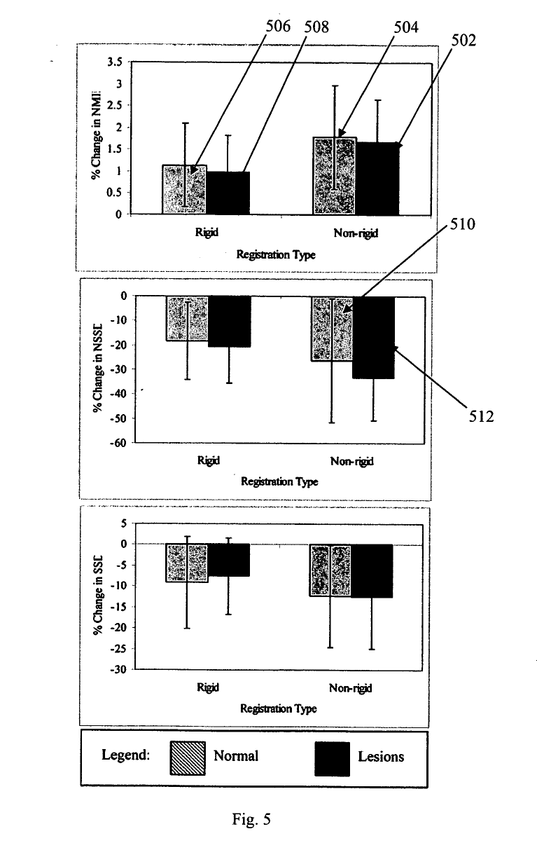

After comparing improvements of the MGE method to the existing Parzen density estimation method, quantitative and visual assessments were carried out on the MGE based registrations in the example embodiment. FIG. 5 is a series of schematic charts showing the indicators of registration quality, for scans with lesions and without lesions (“normal”). The percentage changes in measurements are taken in relation to original measurements of a non-registered image. Generally, increase in NMI infers better registration while decrease in SSD and NSSD generally infer better registration. The results show that non-rigid transformation results in more optimum values than rigid transformation, as can be seen from the generally larger changes for the non-rigid transformation results, for example columns 502, 504 compared to columns 506, 508, and that rigid registration accounts for most of the artifact removal. This is shown by the differences between rigid registration and no registration and between non-rigid registration and rigid registration. In addition, the percentage changes in measurements can be seen to be mainly arising from rigid registration by comparing the length of each column e.g. 506, 508 in the charts for all three measurements. As shown in FIG. 5, NSSD gives higher levels of improvements for scans with lesions, as can be seen from a comparison between column 510 and column 512.

One possible explanation is that NSSD typically eliminates negative intensity changes and this suggests that NSSD to be a more suitable indicator of registration quality than normalised mutual information and SSD, especially for scans with lesions.

A subjective scoring system was used to grade visual improvements in images resulting from registration. The assessments are divided into three categories. “Skin-line registration” considers the boundary of the breast, “breast cone registration” considers the boundaries of the cone-shaped parenchyma, and “residual motion artifacts” is everything else in the imaged breast that has components of less significant image gradient than the earlier two categories. A 4-point score is used, in which the lowest score reflects the best perceived alignment for each category (see Table 3 below for the ratings scale).

TABLE 3
Ratings Scale for visual assessment of registration results

| Feature | Score = 0 | Score = 1 | Score = 2 | Score = 3 |
|---|---|---|---|---|
| Skin-line registration | Excellent | Good | Fair | Poor |
| Breast cone | Excellent | Good | Fair | Poor |
| registration | | | | |
| Residual motion | Minimal | Slight | Moderate | Marked |
| artifacts | | | | |

Table 4 below shows the ratings results after an expert radiologist judged the visual improvement, comparing skin line registration (SKI), breast cone registration (CON), and residual motion artifacts (MOT).

TABLE 4
Visual assessments based on the 4-point score

| Type | Registration | Comparison | SKI | CON | MOT |
|---|---|---|---|---|---|
| Normal | Rigid vs. no | Better (%) | 50.0 | 70.0 | 20.0 |
| Breasts | registration | Same (%) | 50.0 | 30.0 | 80.0 |
| | | Worse (%) | 0.0 | 0.0 | 0.0 |
| | Non-rigid vs. | Better(%) | 50.0 | 40.0 | 25.0 |
| | rigid | Same (%) | 50.0 | 60.0 | 75.0 |
| | | Worse (%) | 0.0 | 0.0 | 0.0 |
| Breasts with | Rigid vs. no | Better (%) | 68.2 | 54.5 | 18.2 |
| lesions | registration | Same (%) | 31.8 | 45.5 | 81.8 |
| | | Worse (%) | 0.0 | 0.0 | 0.0 |
| | Non-rigid vs. | Better (%) | 72.7 | 31.8 | 18.2 |
| | rigid | Same (%) | 18.2 | 68.2 | 81.8 |
| | | Worse (%) | 9.1 | 0.0 | 0.0 |

For normal breasts, rigid registration was at least as good as without registration while non-rigid registration was at least as good as rigid registration. The same was observed for rigid registration vs no registration for breasts with lesions. Two cases of non-rigid registration were observed to be worse than rigid registration (9.1%) for the skin line registration category. Both cases had relatively more severe “ghosting” effects but yet non-rigid registration for these cases was as good as without registration. Thus, non-rigid registration in general improved the visual quality of the images. Skin-line and breast cone registration tends to be better in contrast during comparison than residual motion artifacts registration for both types of breasts. This is because the boundaries of the skin and the breast cones typically have stronger image gradient. It is relatively easier to visually observe improvements in image alignment in regions with stronger image gradient.

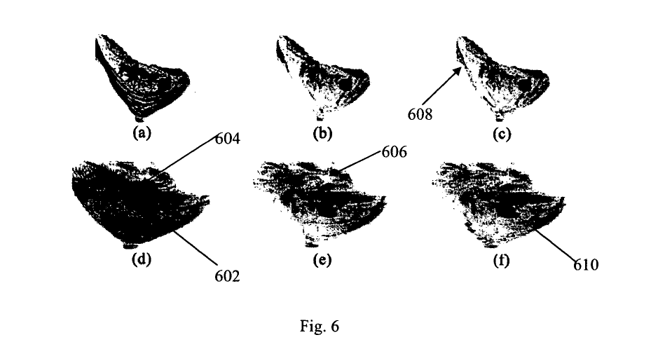

FIG. 6 is a series of images showing inverted difference maximum-intensity projections (MIPs) of a left breast with a benign hemangioma lesion of about 15 mm diameter in the example embodiment. FIG. 6(a) and (d) are MIPs for no registration at axial and at 45 degrees to axial projection respectively FIG. 6(b) and (e) are MIPs for rigid registration at axial and at 45 degrees to axial projection respectively FIG. 6(c) and (f) are MIPs for non-rigid registration at axial and at 45 degrees to axial projection respectively.

In FIG. 6, the darker intensities in the images indicate contrast enhancement and registration artifacts. The lesion 602 in the center of the breast is clearly visible, and registration artifacts e.g. 604 are significantly reduced after rigid registration. The effects of rigid registration account for the removal of most of the visible artefacts (compare numeral 606). Non-rigid registration may not necessarily provide better “skin-line registration”, but “breast cone registration” accuracy improvement by non-rigid registration (see numeral 608) is evident by the preservation of the lesion size and shape (compare numerals 602 and 610) and the preservation is relatively more important in lesion detection and analysis.

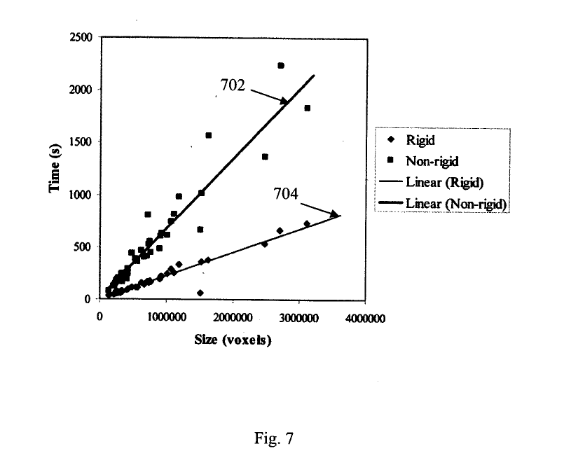

With regards to comparing the efficiency of the registration using the MGE method, the registration in the example embodiment is in theory, much faster than existing methods and can be performed in linear-time. During implementation, the registration was performed on a Pentium IV 2.4 GHz 512 MB system. FIG. 7 is time-voxel size graph illustrating the times taken for both rigid and non-rigid registration in relation to dataset size. The times 702, 704 taken for both non-rigid and rigid registration respectively were approximately linear to the size of the images. Rigid registration (see numeral 704) took about 0.225 ms per voxel while non-rigid registration (see numeral 702) took about 0.670 ms per voxel. The largest registered image (about 3.1 million voxels) took less than an hour (comprising 4 sets of registration) (not shown). Processing time for registration using the Parzen density estimation was significantly longer (about 40% to 380% longer for rigid registration, and about 260% to 750% longer for non-rigid registration) and increased exponentially with dataset size. Thus, based on the timings, the registration in the example embodiment is indeed faster practically and is feasible for use in a clinical environment where high throughput is needed.

In the example embodiment, even if segmentation of lesions is applied to the Parzen density estimation to prevent artificial lesion deformation, the Parzen density estimation may still not be better than the MGE method because a higher dimensional search is still done in the joint histogram for the Parzen density estimation. The MGE method is mathematically similar to finding normalised mutual information using Parzen density estimation but performs the search relatively smoother and in a lower dimensional search space, because of the Gaussian estimation.

The example embodiment described can provide a scheme for entropy-based registration of images, such as in CEMRM, that improves on currently available registration which uses global and local motion modeling and optimizes normalised mutual information. The contrast enhancement model of the example embodiment parameterizes optimization of normalised mutual information using MGE and assumes that the intensity mappings due to motion artifacts and contrast enhancements can be modeled as Gaussians. The assumptions of MGE can be met if the lesions can be removed from registration. Segmenting the lesions during non-rigid registration can result even in less erroneous transformations. Thus, the example embodiment can simplify the registration process, circumventing artificial lesion suppression and reducing registration complexity. Non-rigid registration in the example embodiment can provide accurate diagnosis while the MGE method in the example embodiment can allow normalised mutual information non-rigid registration to be performed more quickly, in a more simplified manner and in linear-time, thus being able to meet the high throughput demands in a clinical environment. Therefore, the example embodiment can enable the CEMRM to become a more reliable tool for breast cancer detection.

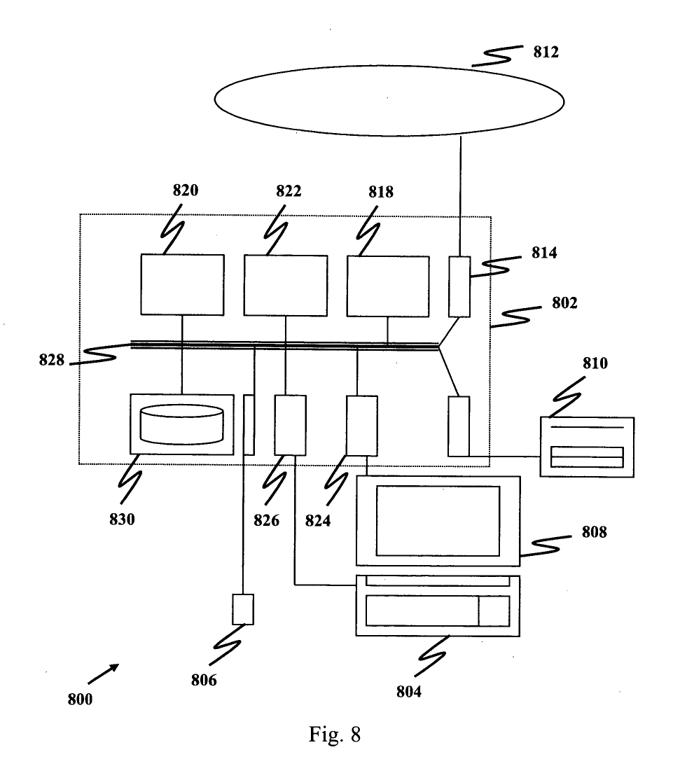

The method and system of the example embodiment can be implemented on a computer system 800, schematically shown in FIG. 8. It may be implemented as software, such as a computer program being executed within the computer system 800, and instructing the computer system 800 to conduct the method of the example embodiment.

The computer system 800 comprises a computer module 802, input modules such as a keyboard 804 and mouse 806 and a plurality of output devices such as a display 808, and printer 810.

The computer module 802 is connected to a computer network 812 via a suitable transceiver device 814, to enable access to e.g. the Internet or other network systems such as Local Area Network (LAN) or Wide Area Network (WAN).

The computer module 802 in the example includes a processor 818, a Random Access Memory (RAM) 820 and a Read Only Memory (ROM) 822. The computer module 802 also includes a number of Input/Output (I/O) interfaces, for example I/O interface 824 to the display 808, and I/O interface 826 to the keyboard 804.

The components of the computer module 802 typically communicate via and interconnected bus 828 and in a manner known to the person skilled in the relevant art.

The application program is typically supplied to the user of the computer system 800 encoded on a data storage medium such as a CD-ROM or floppy disk and read utilising a corresponding data storage medium drive of a data storage device 830. The application program is read and controlled in its execution by the processor 818. Intermediate storage of program data maybe accomplished using RAM 820.

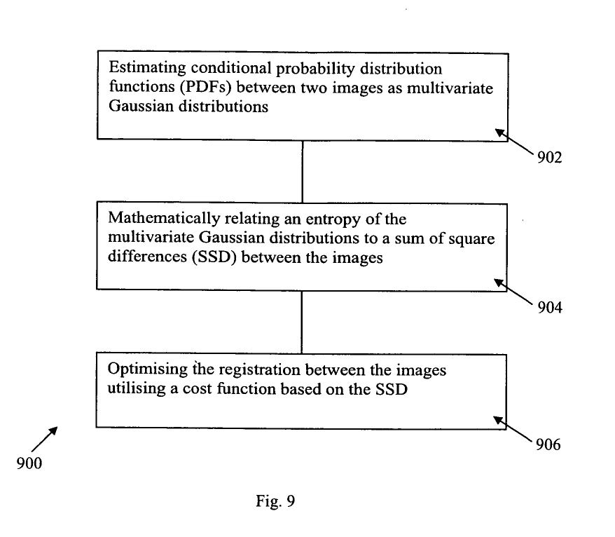

FIG. 9 shows a flow chart 900 illustrating an image registration method according to an example embodiment. At step 902, conditional probability distribution functions (PDFs) between two images are estimated as multivariate Gaussian distributions. At step 904, the entropy of the multivariate Gaussian distributions is mathematically related to a sum of square differences (SSD) between the images. At step 906, the registration between the images is optimised utilising a cost function based on the SSD.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of entropy-based image registration comprising:
estimating conditional probability distribution functions (PDFs) between two images as multivariate Gaussian distributions;
mathematically relating an entropy of the multivariate Gaussian distributions to a sum of square differences (SSD) between the images; and
optimising the registration between the images utilising a cost function based on the SSD.

2. The method as claimed in claim 1, wherein the cost function comprises a linear combination of terms of derivatives of the SSD.

3. The method as claimed in claim 1 or 2, wherein the images comprise 3 dimensional images.

4. The method as claimed in claim 3, wherein the 3 dimensional images comprise contrast enhancement magnetic resonance mammography (CEMRM) images.

5. The method as claimed in claim 4, further comprising analyzing the registration results utilising a scoring technique based on maximum and minimum intensity criteria.

6. The method as claimed in claim 5, wherein the scoring technique is further based on an initial enhancement parameter and a post-initial enhancement parameter.

7. The method as claimed in claim 6, wherein the parameters are varied to reduce blurring effects.

8. The method as claimed claim 7, further comprising lesion segmentation processing.

9. The method as claimed in claim 1, wherein the registration comprises rigid and non-rigid registration.

10. The method as claimed in claim 1, wherein the mathematically relating the entropy of the multivariate Gaussian distributions to the SSD between the images comprises separating motion variables from a non-uniform change in intensity.

11. A system for entropy-based image registration comprising:
means for estimating conditional probability distribution functions (PDFs) between two images as multivariate Gaussian distributions;
means for mathematically relating an entropy of the multivariate Gaussian distributions to a sum of square differences (SSD) between the images; and
means for optimising the registration between the images utilising a cost function based on the SSD.

12. A system for entropy-based image registration comprising:
an estimator for estimating conditional probability distribution functions (PDFs) between two images as multivariate Gaussian distributions;
a correlator for mathematically relating an entropy of the multivariate Gaussian distributions to a sum of square differences (SSD) between the images; and
a processor for optimising the registration between the images utilising a cost function based on the SSD.

13. A computer readable data storage medium having stored thereon computer code means for instructing a computer to execute a method of entropy-based image registration comprising:
estimating conditional probability distribution functions (PDFs) between two images as multivariate Gaussian distributions;
mathematically relating an entropy of the multivariate Gaussian distributions to a sum of square differences (SSD) between the images; and
optimising the registration between the images utilising a cost function based on the SSD.
